(19) United States
(12) Patent Application Publication
(10) Pub. No.: US 2008/0180856 A1
(43) Pub. Date: Jul. 31, 2008

(54) Method and apparatus for a microactuator bonding pad structure for solder ball placement and reflow joint

(76) Inventors: Toshiki Hirano, San Jose, CA (US); Haruhide Takahashi, Odawara (JP); Tatsumi Tsuchiya, Ayase-shi (JP)

Correspondence Address: HITACHI C/O WAGNER BLECHER LLP, 123 WESTRIDGE DRIVE, WATSONVILLE, CA, 95076, US

(21) Appl. No.: 11/701,078

(22) Filed: Jan. 31, 2007

(51) Int. Cl. G11B 5/56

(52) U.S. Cl. 360/294.1; 29/604

(57) ABSTRACT

An apparatus and method for a microactuator having a bonding pad having a solder ball retainer to decrease instances of solder ball movement. The method provides a substrate for the microactuator. A conductive layer above the substrate is provided. A bonding pad having a solder ball retainer is provided and disposed above the conductive layer. The bonding pad having a solder ball retainer provides reduced instances of movement of a solder ball disposed therewithin prior to and during a reflow process performed on the solder ball.

### TECHNICAL FIELD

This invention relates to the field of hard disk drive development.

### BACKGROUND ART

Direct access storage devices (DASD) have become part of everyday life, and as such, expectations and demands continually increase for greater speed for manipulating and for holding larger amounts of data. To meet these demands for increased performance, the mechano-electrical assembly in a DASD device, specifically the Hard Disk Drive (HDD) has evolved to meet these demands.

Advances in magnetic recording heads as well as the disk media have allowed more data to be stored on a disk's recording surface. The ability of an HDD to access this data quickly is largely a function of the performance of the mechanical components of the HDD. Once this data is accessed, the ability of an HDD to read and write this data quickly is a primarily a function of the electrical components of the HDD.

A computer storage system may include a magnetic hard disk(s) or drive(s) within an outer housing or base containing a spindle motor assembly having a central drive hub that rotates the disk. An actuator includes a plurality of parallel actuator arms in the form of a comb that is movably or pivotally mounted to the base about a pivot assembly. A controller is also mounted to the base for selectively moving the comb of arms relative to the disk.

Each actuator arm has extending from it at least one cantilevered electrical lead suspension. A magnetic read/write transducer or head is mounted on a slider and secured to a flexure that is flexibly mounted to each suspension. The read/write heads magnetically read data from and/or magnetically write data to the disk. The level of integration called the head gimbal assembly (HGA) is the head and the slider, which are mounted on the suspension. The slider is usually bonded to the end of the suspension.

A suspension has a spring-like quality, which biases or presses the air-bearing surface of the slider against the disk to cause the slider to fly at a precise distance from the disk. Movement of the actuator by the controller causes the head gimbal assemblies to move along radial arcs across tracks on the disk until the heads settle on their set target tracks. The head gimbal assemblies operate in and move in unison with one another or use multiple independent actuators wherein the arms can move independently of one another.

To allow more data to be stored on the surface of the disk, more data tracks must be stored more closely together. The quantity of data tracks recorded on the surface of the disk is determined partly by how well the read/write head on the slider can be positioned and made stable over a desired data track. Vibration or unwanted relative motion between the slider and surface of disk will affect the quantity of data recorded on the surface of the disk.

To mitigate unwanted relative motion between the slider and the surface of the disk, HDD manufacturers are beginning implement a secondary actuator in close proximity to the slider. A secondary actuator of this nature is generally referred to as a microactuator because it typically has a very small actuation stroke length, typically plus and minus 1 micron. A microactuator typically allows faster response to relative motion between the slider and the surface of the disk as opposed to moving the entire structure of actuator assembly.

### SUMMARY OF THE INVENTION

An apparatus and method for a microactuator having a bonding pad having a solder ball retainer to decrease instances of solder ball movement. The method provides a substrate for the microactuator. A conductive layer above the substrate is provided. A bonding pad having a solder ball retainer is provided and disposed above the conductive layer. The bonding pad having a solder ball retainer provides reduced instances of movement of a solder ball disposed therewithin prior to and during a reflow process performed on the solder ball.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is plan view of an HDD in accordance with an embodiment of the present invention.

FIG. 2 is an inverted isometric view of the slider assembly of FIG. 1, in accordance with an embodiment of the present invention.

FIG. 3A is a plan view of a microactuator solder pad configured with a solder ball retainer in accordance with one embodiment of the present invention.

FIG. 3B is a side view of the solder ball retainer of microactuator solder pad of FIG. 3A in which a solder ball unit is placed therewithin in accordance with an embodiment of the present invention.

FIG. 4A is a sequential block diagram of a process for the fabrication of a solder ball retainer in an embodiment of the present invention.

FIG. 4B is a sequential block diagram of the process for the fabrication of the solder ball retainer of FIG. 4A.

FIG. 4C is a sequential block diagram of a process for the fabrication of the solder ball retainer of FIG. 4B.

FIG. 5A is a sequential block diagram of a process for the fabrication of a solder ball retainer in another embodiment of the present invention.

FIG. 5B is a sequential block diagram of the process for the fabrication of the solder ball retainer of FIG. 5A

FIG. 5C is a sequential block diagram of the process for the fabrication of the solder ball retainer of FIG. 5B.

FIG. 6A is a sequential block diagram of a process for the fabrication of a solder ball retainer in still another embodiment of the present invention.

FIG. 6B is a sequential block diagram of the process for the fabrication of the solder ball retainer of FIG. 6A.

FIG. 6C is a sequential block diagram of the process for the fabrication of the solder ball retainer of FIG. 6B

FIG. 7 is a flow chart illustrating steps of a fabrication process for a solder pad configured with a solder ball retainer in accordance with one embodiment of the present invention.

FIG. 8A is a block diagram of a process for reflowing a solder ball disposed upon a microactuator solder pad retainer in accordance with an embodiment of the present invention.

FIG. 8B is a sequential block diagram of the process of FIG. 8A in which a solder ball is placed within the solder pad retainer prior to a reflow process being performed thereon in accordance with an embodiment of the present invention.

FIG. 8C is a sequential block diagram of the process of FIG. 8B in which a solder ball reflow process is applied to the solder ball in accordance with an embodiment of the present invention.

FIG. 8D is a sequential block diagram of the process of FIG. 8C in which the solder ball has been subjected to a reflow process and the solder ball has been properly reflowed.

### DETAILED DESCRIPTION

Reference will now be made in detail to embodiment(s) of the present invention. While the invention will be described in conjunction with the embodiment(s), it will be understood that they are not intended to limit the invention to these embodiments. On the contrary, the invention is intended to cover alternatives, modifications and equivalents, which may be included within the spirit and scope of the invention as defined by the appended claims.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, and components have not been described in detail as not to unnecessarily obscure aspects of the present invention.

The discussion will begin with an overview of a hard disk drive and components connected within. The discussion will then focus on embodiments of the invention that allow high frequency transmission lines to connect a magnetic recording transducer to a suspension while there is relative motion between the two. The discussion will then focus on embodiments of this invention that allow for retained placement of solder balls prior to and during a reflow process to communicatively couple the transducer and the suspension. Finally fabrication of the high frequency interconnect signal transmission line solder pad will be discussed. Although embodiments of the solder pad will be described in a microactuator, it is understood that the embodiments described herein are useful outside of the art of microactuators, such as devices requiring high frequency transmission between two devices that have relative motion. The utilization of the high frequency interconnect signal transmission line solder pad in a microactuator is only one embodiment and is provided herein merely for purposes of brevity and clarity.

### Overview

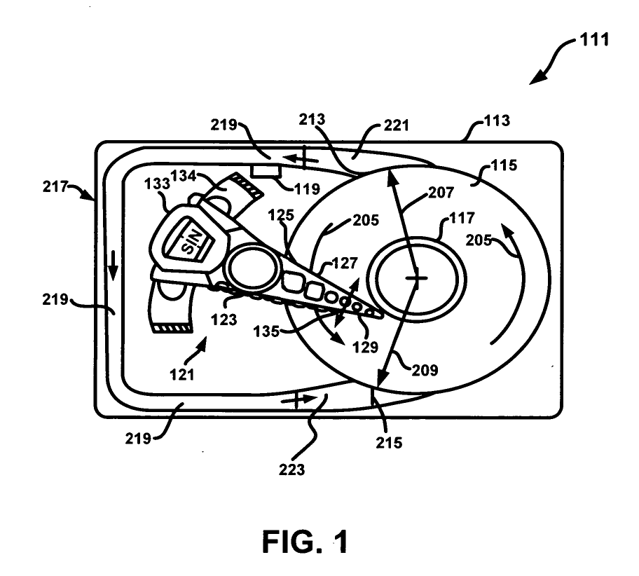

With reference now to FIG. 1, a schematic drawing of one embodiment of an information storage system comprising a magnetic hard disk file or drive 111 for a computer system is shown. Drive 111 has an outer housing or base 113 containing a disk pack having at least one media or magnetic disk 115. A spindle motor assembly having a central drive hub 117 rotates the disk or disks 115. An actuator 121 comprises a plurality of parallel actuator arms 125 (one shown) in the form of a comb that is movably or pivotally mounted to base 113 about a pivot assembly 123. A controller 119 is also mounted to base 113 for selectively moving the comb of arms 125 relative to disk 115.

In the embodiment shown, each arm 125 has extending from it at least one cantilevered electrical lead suspension (ELS) 127 (load beam removed). It should be understood that ELS 127 may be, in one embodiment, an integrated lead suspension (ILS) that is formed by a subtractive process. In another embodiment, ELS 127 may be formed by an additive process, such as a Circuit Integrated Suspension (CIS). In yet another embodiment, ELS 127 may be a Flex-On Suspension (FOS) attached to base metal or it may be a Flex Gimbal Suspension Assembly (FGSA) that is attached to a base metal layer. The ELS may be any form of lead suspension that can be used in a Data Access Storage Device, such as a HDD. A magnetic read/write transducer or head is mounted on a slider 129 and secured to a flexure that is flexibly mounted to each ELS 127. The read/write heads magnetically read data from and/or magnetically write data to disk 115. The level of integration called the head gimbal assembly is the head and the slider 129, which are mounted on suspension 127. The slider 129 is usually bonded to the end of ELS 127

ELS 127 has a spring-like quality, which biases or presses the air-bearing surface of the slider 129 against the disk 115 to cause the slider 129 to fly at a precise distance from the disk. ELS 127 has a hinge area that provides for the spring-like quality, and a flexing interconnect (or flexing interconnect) that supports read and write traces through the hinge area. A voice coil 133, free to move within a conventional voice coil motor magnet assembly 134 (top pole not shown), is also mounted to arms 125 opposite the head gimbal assemblies. Movement of the actuator 121 (indicated by arrow 135) by controller 119 causes the head gimbal assemblies to move along radial arcs across tracks on the disk 115 until the heads settle on their set target tracks. The head gimbal assemblies operate in a conventional manner and always move in unison with one another, unless drive 111 uses multiple independent actuators (not shown) wherein the arms can move independently of one another.

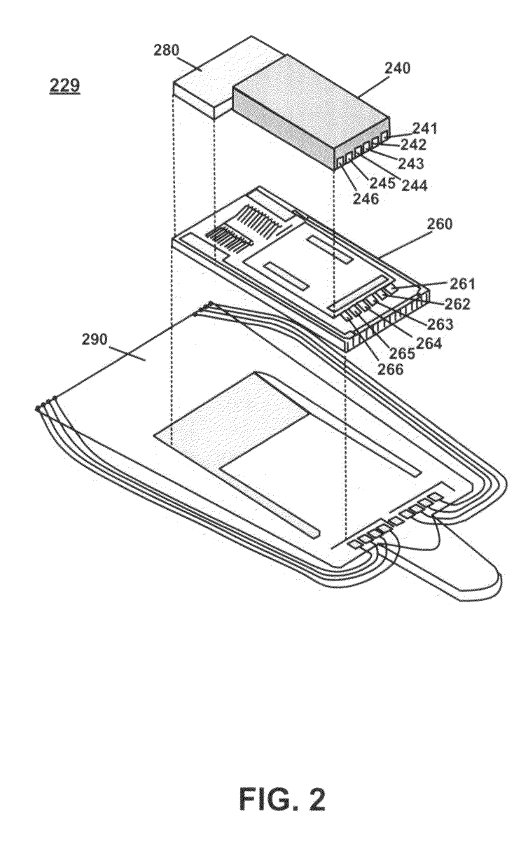

With reference to FIG. 2, detail 229 is the most distal end of the assembly comprising slider 129 of FIG. 1, including a read/write magnetic head 240, a PZT ceramic 280, a suspension 290 and a microactuator 260. When these components are coupled together, as an assembly they are known as a head gimbal assembly or HGA When microactuator 260 is interposed between head 240 and suspension 290 it moves head 240 and PZT ceramic 280 with respect to suspension 290, in accordance to the position of data tracks 135 of FIG. 1.

FIG. 2 is an inverted isometric view of an HGA 229, which is an assembly of slider 129 and an ELS 127 of FIG. 1. HGA 229 shown to include a piezoelectric type (PZT) ceramic 280, a read/write transducer (magnetic head) 240, a microactuator 260, and a suspension 290, each of which are intercommunicatively coupleable and within which microactuator 260 is interposed between magnetic head 240 and suspension 290. In the embodiment shown, microactuator 260 includes a plurality of component data interconnects or data transmission lines terminating in bonding pads 261, 262, 263, 264, 265 and 266, and magnetic head 240 includes a plurality of data transmission lines terminating in bonding pads 241, 242, 243, 244, 245 and 246. It is noted that each data communication line associated with each bonding pad 241-246 or 261-266 may terminate within and/or couple with another line within and/or provide an additional externally accessible communicative connection for the component in which it is disposed. It is further noted that bonding pad 261 of microactuator 260 is associated with bonding pad 241 of magnetic head 240; pad 262 is associated with pad 242, and so on.

Although six bonding pads are shown on microactuator 260 of FIG. 2, it is noted that microactuator 260 may be configured to have a greater or lesser number of bonding pads.

Although embodiments of the present invention are described in the context of a microactuator in an information storage system, it should be understood that embodiments may apply to devices utilizing an electrical interconnect that might experience solder ball movement prior to and during a reflow process performed thereon. For example, embodiments of the present invention may apply to rigid printed circuit boards. More specifically, embodiments of the present invention may be used in printed circuit boards that are used for high speed signal processing. Embodiments of the present invention are also suitable for use in flexing circuits, e.g., flexing circuits for digital cameras and digital camcorders. The signal traces may also be replaced with power traces according to one embodiment.

In the embodiment shown, suspension 290 includes a base-metal layer which can be comprised in part of stainless steel. Although stainless steel is stated herein as the base-metal layer, it is appreciated that a plurality of metals may be utilized as the base-metal layer of suspension 290.

### BEST MODES FOR CARRYING OUT THE INVENTION

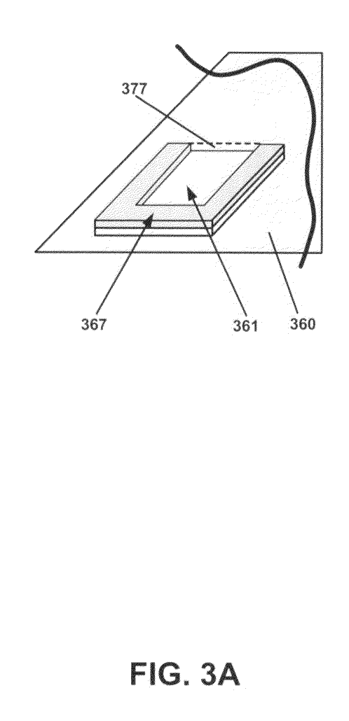

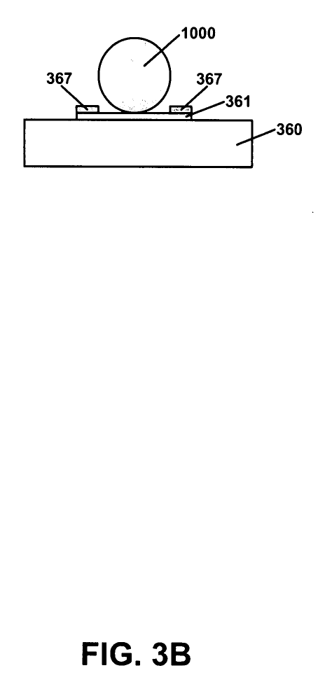

FIG. 3A is an angled view of a solder ball retainer 367 implemented on a microactuator 360 having a bonding pad 361 disposed thereon. In an embodiment of the present invention, apparatus 367 is shown to be configured in an elevated open ended rectangular shape, relative to solder pad 361, upon which apparatus 367 is disposed. In the present configuration, open end 377 of apparatus 367 is oriented toward the component to which microactuator 360 is to be communicatively coupled. Alternatively, apparatus 367 may be configured in nearly any shape including, but not limited to, close-ended rectangular, ovoidal, conical, circular, triangular, a combination thereof, or other shape with the caveat that the shape provides analogous solder ball retentive and reflow characteristics.

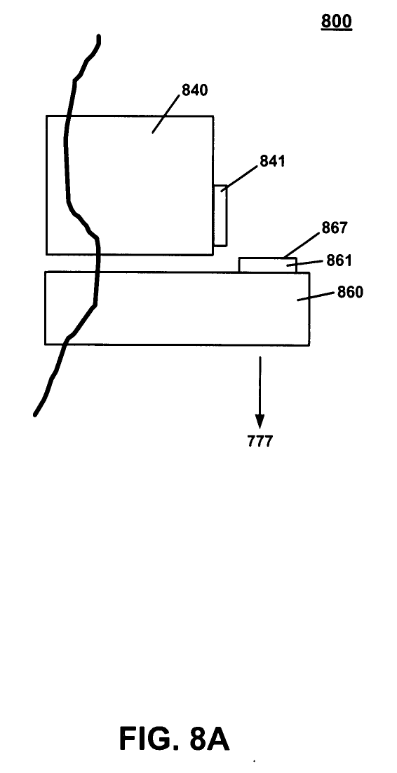

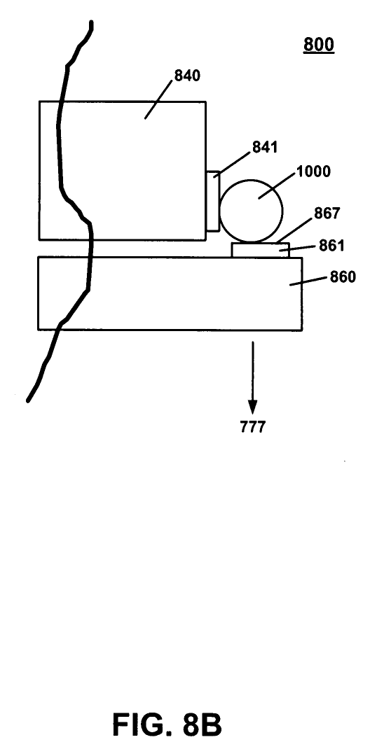

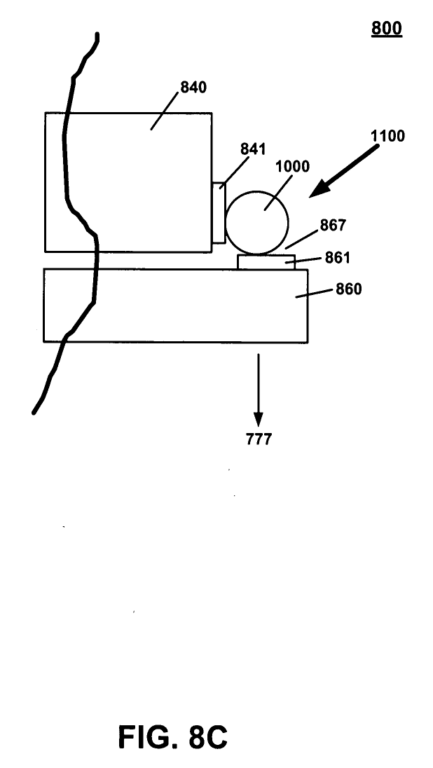

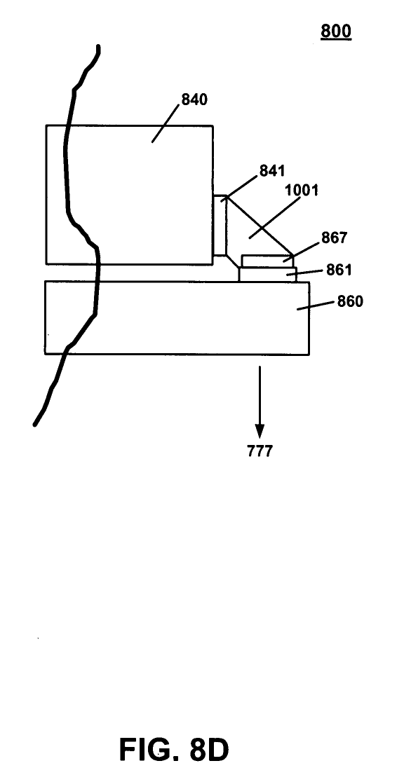

FIG. 3B is a profile view of the solder ball retainer 367 of FIG. 3A in which a solder ball 1000 is shown disposed within apparatus 367. By virtue of the elevated ridge created above solder pad 361 by apparatus 367, unit 1000 is retained in a reflow position prior to a reflow process, e.g., process 800 of FIGS. 8A-8D, being performed thereon.

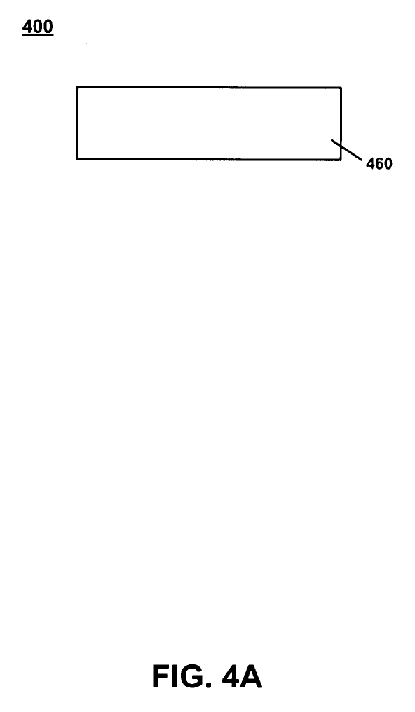

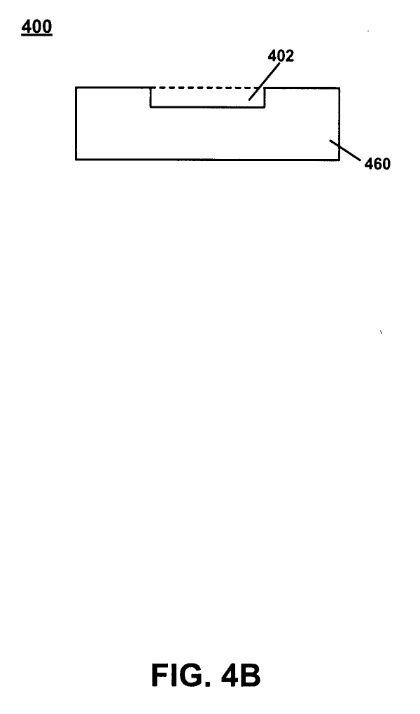

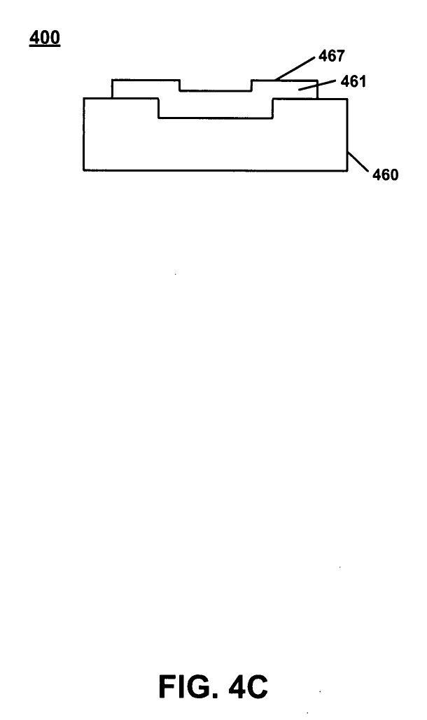

FIGS. 4A, 4B and 4C are sequential block diagrams of a process 400 for the fabrication of a solder ball retainer 467 in an embodiment of the present invention.

FIG. 4A is a block diagram of process 400 for fabricating an apparatus 467 in which an initial substrate 460 is fabricated. In the present embodiment, substrate 460 is fabricated from silicon. It is noted that nearly any substrate fabrication process may be utilized to fabricate substrate 460.

FIG. 4B is a sequential block diagram of process 400 of FIG. 4A. Substrate 460 is shown to have had a subtractive process thereon, such that substrate 460 has a trough 402 formed therewithin, in an embodiment of the present invention. It is noted that nearly any substrate subtraction process may be utilized to fabricate trough 402 in substrate 650. Nearly any subtraction process including, but not limited to, etching can be utilized to create trough 402.

FIG. 4C is a sequential block diagram of process 400 of FIG. 4B. Substrate 460, configured with trough 402, is shown to have fabricated thereon a bonding pad 461 having a solder ball retainer 467 via a deposition additive process. It is noted that nearly any deposition process may be utilized to fabricate apparatus 467. In the present embodiment, apparatus 467 is characteristically compatible to substrate 460.

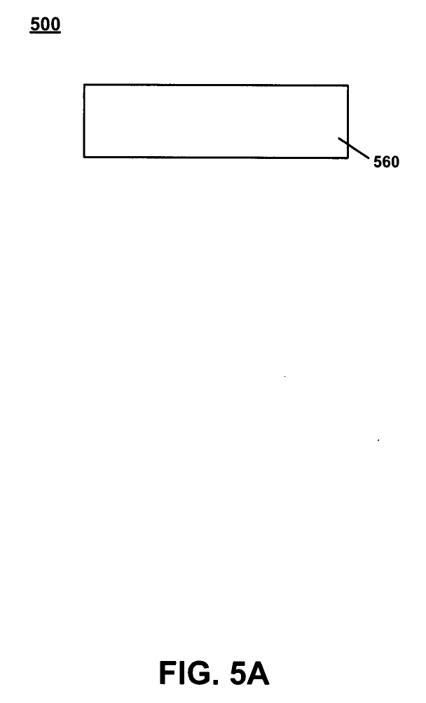

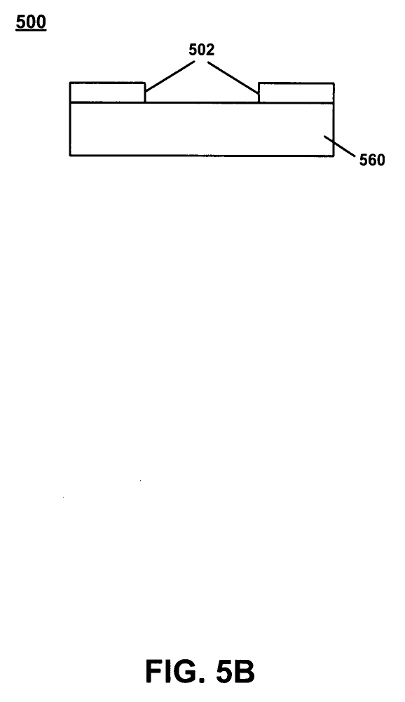

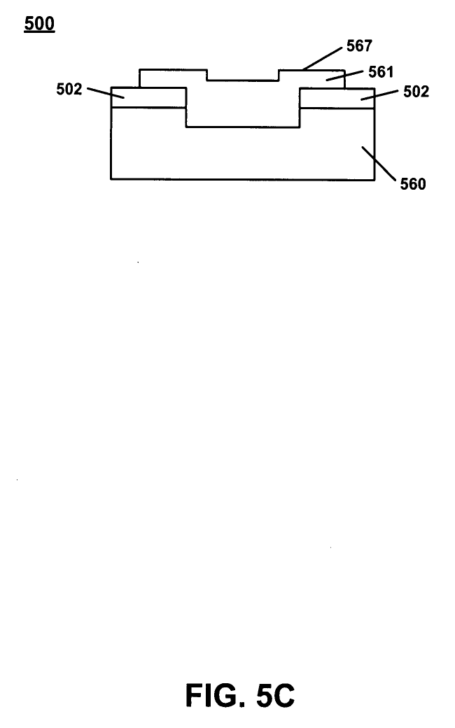

FIGS. 5A, 5B and 5C are sequential block diagrams of a process 500 for the fabrication of a solder ball retainer 567 in another embodiment of the present invention.

FIG. 5A is a block diagram of process 500 for fabricating an apparatus 567 in which an initial substrate 560 is fabricated. In the present embodiment, substrate 560 is fabricated from silicon. It is noted that nearly any substrate fabrication process may be utilized to fabricate substrate 560.

FIG. 5B is a sequential block diagram of process 500 of FIG. 5A. Substrate 560 is shown to have had an additive process performed thereon, such that that substrate 560 has a spacer layer 502 disposed above substrate 560. In the present embodiment, fabrication of spacer layer 502 creates a trough formed above substrate 560, in an embodiment of the present invention. It is noted that nearly any additive process may be utilized to fabricate spacer layer 502 on substrate 560. In the present embodiment, spacer layer 502 is characteristically compatible to substrate 560.

FIG. 5C is a sequential block diagram of process 500 of FIG. 5B. Substrate 560, configured with spacer layer 502, is shown to have fabricated thereon a bonding pad 561 having a solder ball retainer 567 included therewith via a deposition process. It is noted that nearly any deposition process may be utilized to fabricate apparatus 567. In the present embodiment, apparatus 567 is characteristically compatible with space layer 502 and substrate 560.

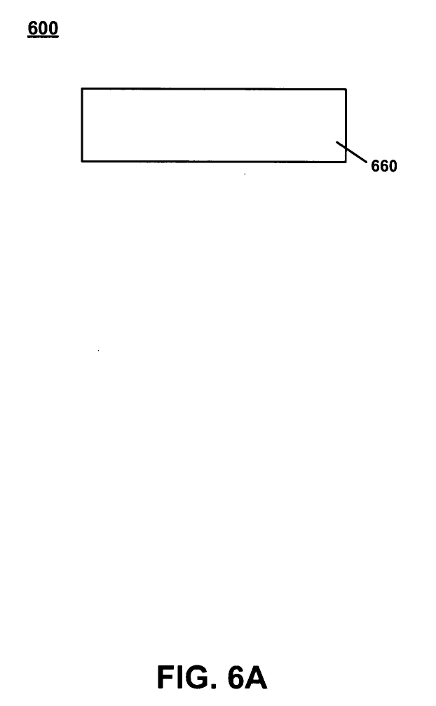

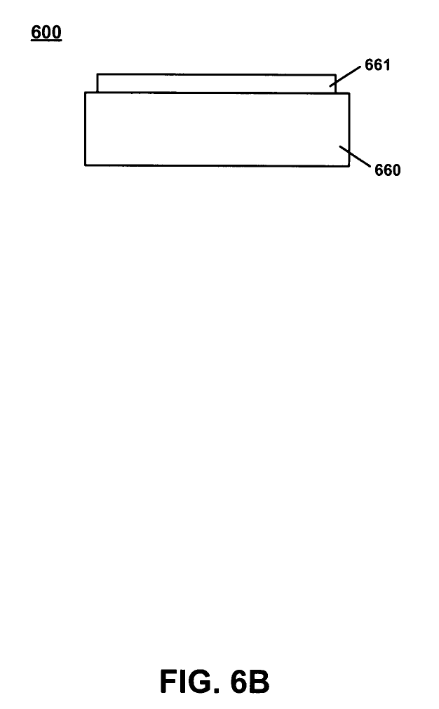

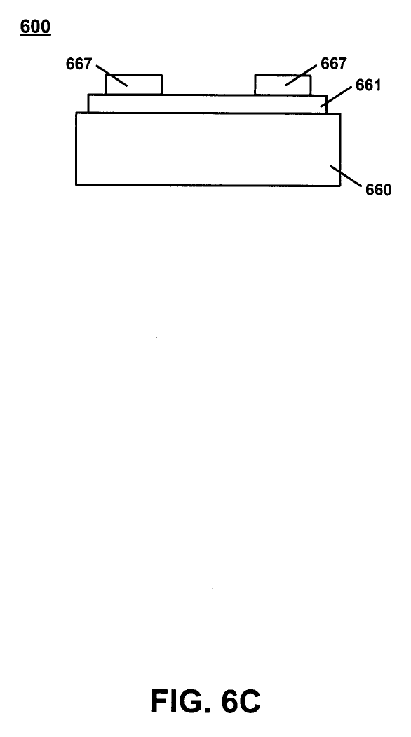

FIGS. 6A, 6B and 6C are sequential block diagrams of a process 600 for the fabrication of a solder ball retainer 667 in yet another embodiment of the present invention.

FIG. 6A is a block diagram of process 600 for fabricating an apparatus 667 in which an initial substrate 660 is fabricated. In the present embodiment, substrate 660 is fabricated from silicon. It is noted that nearly any substrate fabrication process may be utilized to fabricate substrate 660.

FIG. 6B is a sequential block diagram of process 600 of FIG. 6A. Substrate 660 is shown to have had an additive process performed thereon, such that that substrate 660 has a substantially flat bonding pad 661 disposed above substrate 660. In the present embodiment, fabrication of flat bonding pad 661 creates an elevated surface above substrate 660 in an embodiment of the present invention. It is noted that nearly any additive process may be utilized to fabricate flat bonding pad 661 on substrate 660. In the present embodiment, flat bonding pad 661 is characteristically compatible to substrate 660.

FIG. 6C is a sequential block diagram of process 600 of FIG. 6B. Substrate 660, configured with flat bonding pad 656, is shown to have had fabricated thereon a solder ball retainer 667 via a deposition additive process. It is noted that nearly any deposition process may be utilized to fabricate apparatus 667. In the present embodiment, apparatus 667 is characteristically compatible with flat bonding pad 661 and substrate 660.

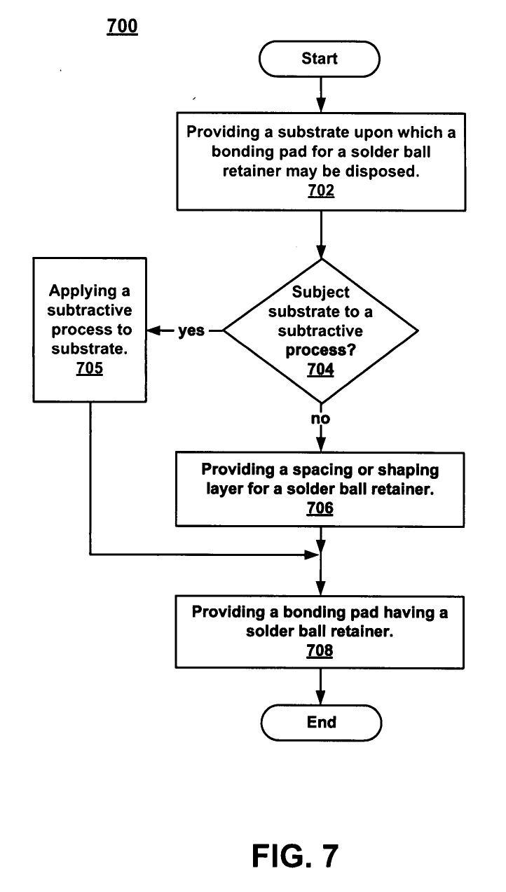

FIG. 7 is a flowchart of a process 700 for fabricating a solder ball retainer in an embodiment of the present invention. FIG. 7 is a flow chart of a process 700 in which particular steps are performed in accordance with an embodiment of the present invention for fabricating a bonding pad having a solder ball retainer for disposition upon a bonding pad of micro-electromechanical signal transmission line. Although specific steps are disclosed in process 700, such steps are exemplary. That is, the present invention is well suited to performing various other steps or variations of the steps recited in FIG. 7. Within the present embodiment, it should be appreciated that the steps of process 700 may be performed by software, by hardware, by an assembly mechanism, through human interaction, or by any combination of software, hardware, assembly mechanism, and human interaction.

Process 700 will be described with reference to elements shown in FIGS. 3A-3B, FIGS. 4A-4C, FIGS. 5A-5C, FIGS. 6A-6C, and FIGS. 8A-8D.

In step 702 of process 700, a suitable substrate, e.g., substrate 360, 460, 560, 660 or 860 of FIGS. 3A-3B, FIGS. 4A-4C, FIGS. 5A-5C, FIGS. 6A-6C, and FIGS. 8A-8D, respectively, is introduced into process 700 in an embodiment of the present invention. A suitable substrate for a bonding pad with a solder ball in accordance with an embodiment of the present invention is typically silicon. Other substrates such as glass, quartz or ceramic may also be suitable for process 700.

In step 704 of process 700, the substrate may be subjected to a subtractive process. Accordingly, if the process necessitates a subtractive process, process 700 proceeds to step 705. Alternatively, if a subtractive process is not utilized, process 700 proceeds to step 706.

In step 705 of process 700, a substrate, e.g., substrate 460 of FIGS. 4A-4C, is subjected to a subtractive process, such that substrate 460 is ditched, creating a trough 402 (FIGS. 4B and 4C) therein, in an embodiment of the present invention. A typical subtractive process is by wet-etching that dissolves the metal, or ion-milling, which is a physical method of removing surface material by accelerated ions in low-pressure plasma, although alternative subtractive processes may be utilized.

In step 706 of process 700, a material, e.g., spacer layer 502 of FIG. 5B and flat bonding pad 661 of FIG. 6B, is deposited onto portions of a substrate e.g., substrate 560, 660 (FIG. 5B, FIG. 6B, respectively) in an embodiment of the present invention. In an embodiment, space layer 502 (FIG. 5B) may be conductive, thus providing a signal conducting layer. In an alternative embodiment, space layer 502 may be non-conductive. In the present embodiment, flat bonding pad 661 (FIG. 6B) is conductive, thus also providing a signal conducting layer. In an embodiment, spacer layer 502 and flat bonding pad 661 are formed within the projected confines of the peripheral edge of a bonding pad having a solder ball retainer. Additionally, spacer layer 502 provides shaping for the bonding pad to be disposed thereon. A conductive material may comprise an adhesion layer such as chromium or titanium possibly followed by a layer of copper or gold. The usual deposition technique for these materials is known in the industry as sputter deposition. Other deposition techniques may also be used such as chemical vapor deposition (CVD), electro-plating or evaporation. In another embodiment of the present invention electroless plating is used to apply a conductive material.

In step 708 of process 700, a bonding pad configured with a solder ball retainer structure (e.g., solder ball retainer 467, 567, 667, 867 of FIGS. 4C, 5C, 6C and 8C, respectively) is formed over substrate 460 and trough 402 of FIG. 4B, substrate 560 and ridges 502 of FIG. 5B or substrate 660 and spacer layer 661 of FIG. 6B, respectively, thus creating an apparatus for retaining a solder ball prior to and during a reflow process performed on the solder ball, in accordance with an embodiment of the present invention. The usual deposition technique for these materials is known in the industry as sputter deposition. Other deposition techniques may also be used such as chemical vapor deposition (CVD), electro-plating or evaporation. In another embodiment of the present invention electroless plating is used to apply a conductive material.

In an embodiment of the present invention, via the deposition process described in FIG. 4C, a solder ball retention structure 467 is formed in conjunction with bonding pad 461 above trough 402 of FIG. 4B, thus creating a bonding pad configured to retain a solder ball therewithin prior to and during a reflow process performed on the solder ball.

In another embodiment of the present invention, via the deposition described in FIG. 5C, a solder ball retention structure 567 is formed in conjunction with bonding pad 561 above ridges 502, thus creating a bonding pad configured to retain a solder ball therewithin prior to and during a reflow process performed on the solder ball.

In still another embodiment of the present invention, via the deposition process described in FIG. 6C, a ridge 667 is formed above flat bonding pad 661, thus creating a bonding pad configured to retain a solder ball therewithin prior to and during a reflow process performed on the solder ball.

FIG. 8A is a block diagram illustrating the relationship of a microactuator 860 having been adhesively oriented relative to a magnetic head 840 in preparation for a reflow process 900 being performed on a solder ball disposed thereon. It is noted that magnetic head 840 and microactuator 860 are analogous to magnetic head 240 and microactuator 260 of FIG. 2. In the present embodiment, microactuator 860 has disposed thereon a solder pad 861 and upon which is disposed a solder ball retainer 867 in accordance with an embodiment of the present invention.

In the present embodiment, apparatus 867 is shown to be disposed upon that solder pad upon which a natural force, e.g., gravity 777, exerts the greatest force, e.g., horizontally oriented solder pad 861. It is particularly noted that in an alternative embodiment, apparatus 867 may be practiced on both bonding pads 861 and 841, dependent upon the solder reflow characteristics and solder control requirements of the system into which apparatus 867 is to be implemented.

FIG. 8B is a sequential block diagram of the reflow process 800 of FIG. 8A being performed therein. Shown is the placement of a solder ball 1000 within the solderable unit solder ball retainer 867 of microactuator 860 in preparation to receive a reflow process thereon.

FIG. 8C is a sequential block diagram of the reflow process 800 of FIG. 8B being performed therein. Shown is an energy source 1100 being applied to solder ball 1000 in accordance with the reflow process 800 being performed. In accordance with an embodiment of the present invention, reflowing solder is used for electrically coupling bonding pad 861 configured with solder ball retainer 867 with bonding pad 841.

The following is presented only as examples of solder reflow techniques and is not intended to limit the scope of the embodiment of the present invention. There are many solder reflow techniques. They include, but are not limited to: placing a solder preform, such as a solder ball, in solder ball retainer 867, followed with the application of an energy source 1100. Energy source 1100 can be, but is not limited to, a laser, a focused infrared light, an oven, and the like. Alternatively, tinning, which is the technique of applying a film of solder on a surface is varied and well known in the art may be implemented.

FIG. 8D is a sequential block diagram of the reflow process 800 of FIG. 8C being performed therein. Shown is melted and solidified solder 1001 subsequent to reflow a process 800 being performed thereon, in which solder 1001 has been properly reflowed, thus providing a communicative coupling between head 840 and microactuator 860, in accordance with an embodiment of the present invention.

The present invention, in the various presented embodiments allows for the fabrication of a bonding pad that provides retention of a solder ball disposed therewithin, such that instances of movement of the solder ball prior to and during a reflow process performed on the solder ball are reduced. Embodiments of the present invention further realize that by virtue of retained solder ball placement, instances of cross-wiring, overflow, and improper reflow of the solder are also reduced.

The foregoing descriptions of specific embodiments of the present invention have been presented for purposes of illustration and description. They are not intended to be exhaustive or to limit the invention to the precise forms disclosed, and many modifications and variations are possible in light of the above teaching. The embodiments described herein were chosen and described in order to best explain the principles of the invention and its practical application, to thereby enable others skilled in the art to best utilize the invention and various embodiments with various modifications. as are suited to the particular use contemplated. It is intended that the scope of the invention be defined by the Claims appended hereto and their equivalents.

What is claimed is:

1. A method for providing a bonding pad to reduce instances of improper solder ball placement comprising:
providing a substrate layer upon which said bonding pad is disposed;
providing a signal conductive layer above said substrate layer, said signal conductive layer comprising a bonding pad portion having a base surface;
providing a retentive portion above said base surface of said bonding pad portion, said retentive portion configured to positionally retain a solder ball placed therewithin prior to and during a reflow process performed on said solder ball.

2. The method as recited in claim 1 wherein said providing said retentive portion further comprises forming a spacer layer interposed between said base surface of said bonding pad portion and said retentive portion.

3. The method as recited in claim 2 further comprising:
forming an elevated surface disposed above said spacer layer and proximal to peripheral edge of said base surface of said bonding pad portion.

4. The method as recited in claim 1 wherein said providing a retentive portion further comprises performing a subtractive process on said substrate layer to create a trough in said substrate layer, said subtractive process performed within an internal portion of peripheral edge of said base portion so as to elevate said peripheral edge relative to said substrate layer upon which said subtractive process is performed.

5. The method as recited in claim 4 further comprising:
performing an additive process on said base portion to form said solder ball retainer above said base portion of said bonding pad portion, said additive process performed within peripheral edge of said bonding pad portion.

6. The method as recited in claim 1 wherein said providing a retentive portion further comprises performing an additive process on said base portion to form said solder ball retainer above said base portion of said bonding pad portion, said additive process performed within peripheral edge of said bonding pad portion.

7. A microactuator having a solder ball retainer for reduced instances of solder ball movement, said microactuator comprising:
a substrate upon which said solder ball retainer in disposed;
a signal conductive layer above said substrate, said signal conductive layer comprising:
a solder pad portion having a base surface; and
a retentive portion above said base surface, said retentive portion disposed within peripheral edge of said base surface, said retentive portion for retaining therewithin a solder ball prior to and during a reflow process performed on said solder ball, said retentive portion reducing instances of said solder ball movement.

8. The microactuator of claim 7 wherein said substrate further comprises a depression formed therein, said depression formed within peripheral edge of said base surface of said solder pad portion.

9. The microactuator of claim 8 wherein said solder pad portion is formed above said depression.

10. The microactuator of claim 9 wherein said retentive portion is disposed above said solder pad portion.

11. The microactuator of claim 7 wherein said solder pad portion comprises an elevated ridge structure disposed above said substrate, said elevated ridge structure formed within peripheral edge of said solder pad portion.

12. The microactuator of claim 11 wherein said retentive portion is disposed above said elevated ridge structure of said solder pad portion, said retentive portion formed within said peripheral edge.

13. The microactuator as recited in claim 7 wherein said retentive portion forms a trough.

14. A hard disk drive comprising:
a housing;
a disk pack mounted to the housing and having a, at least one, disk that is/are rotatable relative to the housing, the disk pack defining an axis of rotation and a radial direction relative to the axis, and the disk pack having a downstream side wherein air flows away from the disks, and an upstream side wherein air flows toward the disk;
an actuator mounted to the housing and being movable relative to the disk pack, the actuator having one or more heads for reading data from and writing data to the disks; and
an electrical lead suspension, said electrical lead suspension (ELS) having a microactuator, said microactuator having a bonding pad retainer to decrease movement of a solder ball disposed thereon, said microactuator comprising:
a substrate layer upon which said bonding pad retainer is disposed; and
a signal conductive layer above said substrate layer, said signal conductive layer comprising:
a solder pad portion having a base surface; and
a retentive portion above said base surface, said retentive portion disposed within peripheral edge of said base surface, said retentive portion for retaining therewithin a solder ball prior to and during a reflow process performed on said solder ball, said retentive portion reducing instances of said solder ball movement.

15. The hard disk drive of claim 14 wherein said substrate layer further comprises a trough formed therein via a subtractive process, said subtractive process performed within an internal portion of peripheral edge of said substrate layer so as to elevate said peripheral edge relative to said substrate layer upon which said subtractive process is performed.

16. The hard disk drive of claim 15 wherein said bonding pad portion is disposed above said trough.

17. The hard disk drive of claim 16 wherein said retentive portion is disposed above said bonding pad portion.

18. The hard disk drive as recited in claim 14 wherein said base portion further comprises a ridge formed thereon, said ridge formed within peripheral edge of said base portion.

19. The hard disk drive as recited in claim 18 wherein said retentive portion is disposed above said ridge, said retentive portion disposed within said peripheral edge of said base portion.

20. The hard disk drive of claim 14 wherein said retentive portion is a structural trough.
